(19) United States
(12) Patent Application Publication
(10) Pub. No.: US 2017/0021603 A1
(43) Pub. Date: Jan. 26, 2017

(54) SHEET PROCESSING APPARATUS AND LAMINATION METHOD

(71) Applicants: KABUSHIKI KAISHA TOSHIBA, Tokyo (JP); TOSHIBA TEC KABUSHIKI KAISHA, Tokyo (JP)

(72) Inventor: Hideyuki Kikuchi, Sunto (JP)

(21) Appl. No.: 14/805,603

(22) Filed: Jul. 22, 2015

(51) Int. Cl. B32B 37/14; B32B 37/00

(52) U.S. Cl. CPC B32B 37/14; B32B 37/0053

(57) ABSTRACT

A sheet processing apparatus comprises a first conveyance unit, a sheet discharging unit, a lamination film feeding unit, a locating unit and a folding unit. An image forming apparatus comprises a second conveyance unit, a conveyance path switching unit, a film stacking unit and a lamination unit. The second conveyance unit inserts the sheet conveyed by the first conveyance unit into the groove formed on the lamination film by the folding unit. The conveyance path switching unit switches the destination of the sheet conveyed by the first conveyance unit to either of the first discharging unit and the second conveyance unit. The film stacking unit causes the outer surface and the inner surface of the sheet inserted into the groove to adhere to the lamination film so as to form a lamination sheet. The lamination unit laminates the lamination sheet.

### FIELD

Embodiments described herein relate generally to a sheet processing apparatus and a lamination method.

### BACKGROUND

To be stored or presented, sheets on which images are printed are laminated in some cases. During a lamination process, a sheet is clamped in a lamination film. Further, during the lamination process, the lamination film clamping the sheet is heated and pressurized. Mostly, the lamination processing is carried out by a lamination processor.

Sometimes, an image forming apparatus such as a copier or a printer is used for image printing. In this case, the user first prints an image using the image forming apparatus and then carries out a lamination processing using a lamination processor. The user causes a lamination film to clamp the image, places a lamination sheet clamping the image in the lamination processor and operates the lamination processor to implement a lamination processing. In this lamination mode, it takes the user a lot of time to laminate a plurality of images.

It is urgently desired to laminate the images printed by an image forming apparatus easily and rapidly.

### DESCRIPTION OF THE DRAWINGS

FIG. 1 is a schematic sectional view exemplifying the whole structure of an image forming apparatus of embodiment 1 equipped with a sheet processing apparatus;

FIG. 2 is a schematic sectional view exemplifying the structure of a sheet processing apparatus according to embodiment 1;

FIG. 3 is a block diagram exemplifying the functional structure of a sheet processing apparatus according to embodiment 1;

FIG. 4A is a schematic sectional view exemplifying the structures of a folding unit and a film stacking unit of a sheet processing apparatus according to embodiment 1;

FIG. 4B is a schematic sectional view illustrating a sheet processing apparatus in which a protrusion plate in a folding unit is in an entered state according to embodiment 1;

FIG. 5 is a three-dimensional schematic diagram exemplifying a lamination sheet formed by a sheet processing apparatus according to embodiment 1;

FIG. 6 is a flowchart illustrating the flow of a lamination method using a sheet processing apparatus according to embodiment 1;

FIG. 7 is a flowchart illustrating an action of folding a lamination film in a sheet processing apparatus according to embodiment 1;

FIG. 8 is a schematic sectional view illustrating the actions of a sheet processing apparatus according to embodiment 1;

FIG. 9 is a schematic sectional view illustrating a location action and a folding action based on a sheet processing apparatus according to embodiment 1;

FIG. 10 is a flowchart illustrating the flow of an image formation action implemented in a sheet processing apparatus according to embodiment 1;

FIG. 11 is a schematic sectional view illustrating the actions of a sheet processing apparatus according to embodiment 1;

FIG. 12A is a schematic sectional view illustrating the actions implemented in a folding unit of a sheet processing apparatus according to embodiment 1;

FIG. 12B is a schematic sectional view illustrating the actions implemented in a folding unit of a sheet processing apparatus according to embodiment 1;

FIG. 13 is a schematic sectional view illustrating the actions of a sheet processing apparatus according to embodiment 1;

FIG. 14 is a three-dimensional schematic diagram exemplifying a lamination sheet formed by an image forming apparatus according to embodiment 1;

FIG. 15 is a schematic sectional view exemplifying the main structure of a sheet processing apparatus according to a variation (a first variation) of embodiment 1;

FIG. 16 is a schematic sectional view exemplifying the structure of a sheet processing apparatus according to embodiment 2; and

FIG. 17 is a block diagram exemplifying the functional structure of an image forming apparatus according to embodiment 3.

### DETAILED DESCRIPTION

In accordance with embodiments of the present invention, a sheet processing apparatus comprises a first conveyance unit, a sheet discharging unit, a lamination film feeding unit, a locating unit and a folding unit. The sheet processing apparatus further comprises a second conveyance unit, a conveyance path switching unit, a film stacking unit and a lamination unit. The first conveyance unit conveys a sheet discharged from the image forming apparatus. The sheet discharging unit discharges the sheet conveyed by the first conveyance unit. The lamination film feeding unit feeds a lamination film. The locating unit locates the lamination film fed from the lamination film feeding unit. The folding unit folds the lamination film located at the locating unit to form a groove having a V-shaped section on the lamination film. The second conveyance unit inserts the sheet conveyed by the first conveyance unit into the groove on the lamination film. The conveyance path switching unit switches the destination of the sheet conveyed by the first conveyance unit to either of the first discharging unit and the second conveyance unit. The film stacking unit causes the outer surface and the inner surface of the sheet inserted into the groove to adhere to the lamination film so as to form a stacked sheet. The lamination unit laminates the stacked sheet.

The sheet processing apparatus, the image forming apparatus and the lamination method disclosed herein are described below with reference to accompanying drawings in each of which identical reference signs denote identical components, if not specified.

### Embodiment 1

The sheet processing apparatus and the lamination method of embodiment 1 are described below.

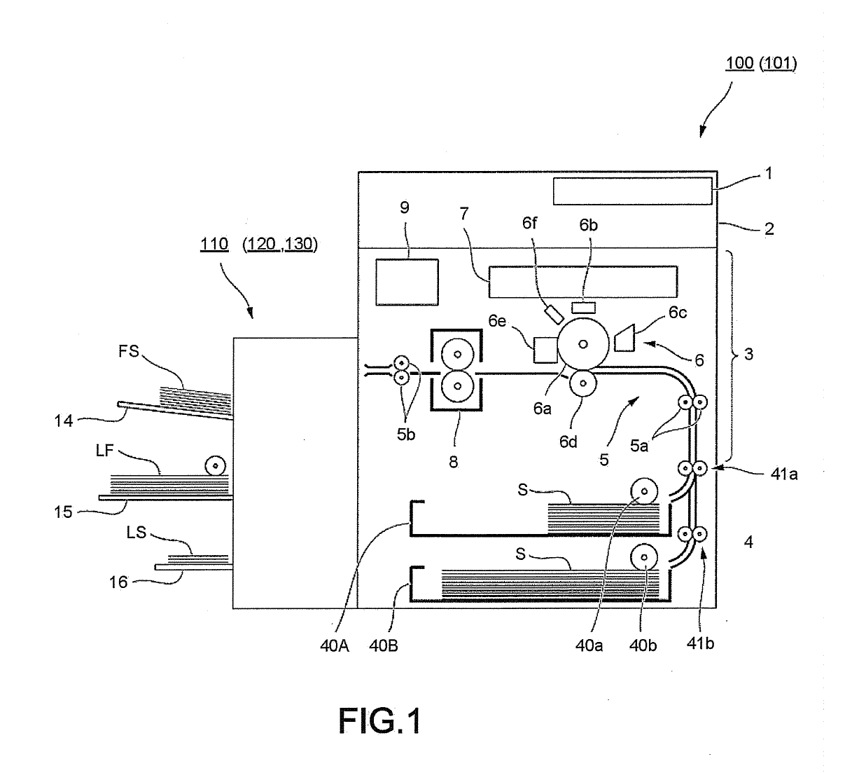

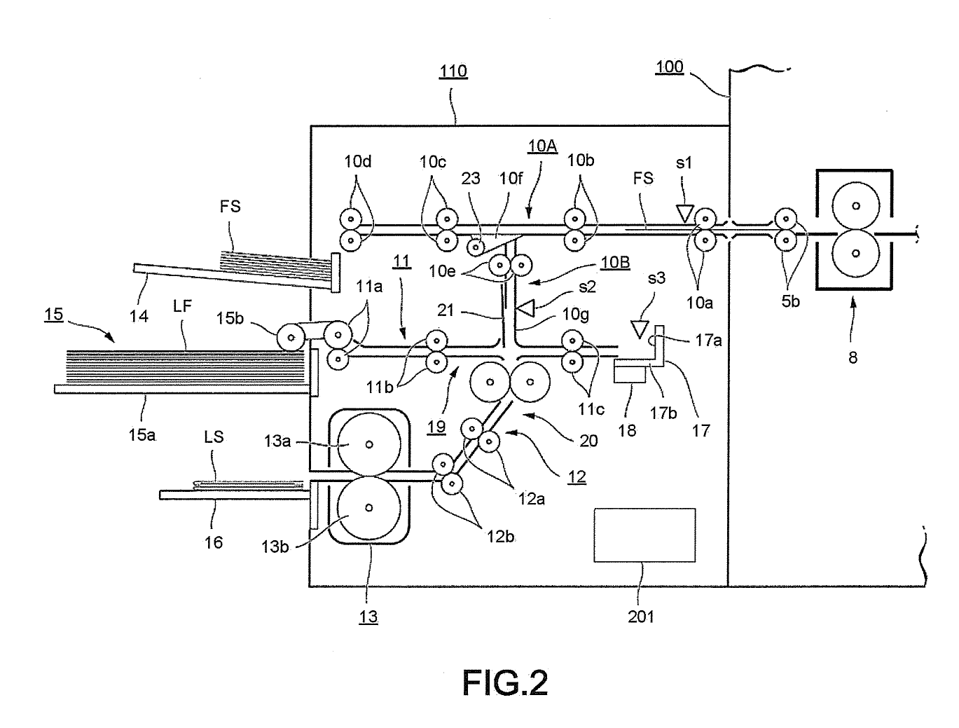

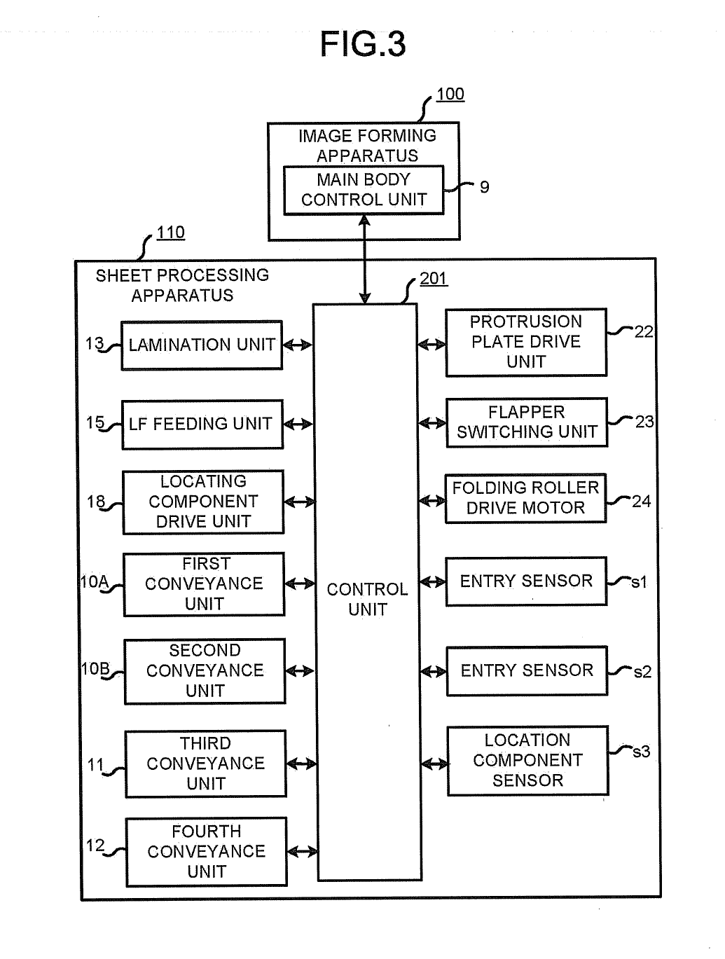

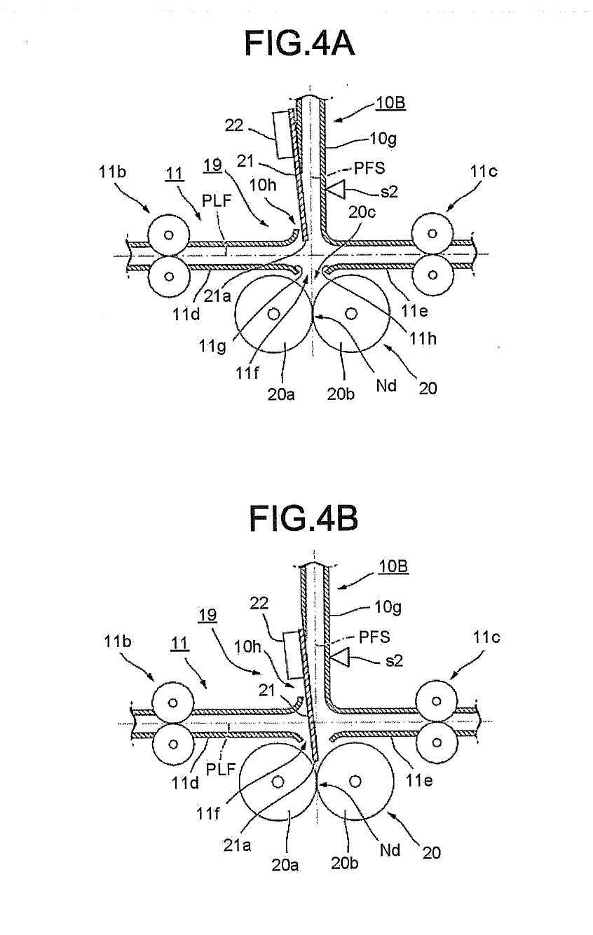

FIG. 1 is a schematic sectional view exemplifying the whole structure of an image forming apparatus of embodiment 1 equipped with a sheet processing apparatus. FIG. 2 is a schematic sectional view exemplifying the structure of a sheet processing apparatus according to embodiment 1. FIG. 3 is a block diagram exemplifying the functional structure of a sheet processing apparatus according to embodiment 1. FIG. 4A is a schematic sectional view exemplifying the structures of a folding unit and a film stacking unit of a sheet processing apparatus according to embodiment 1. FIG. 4B is a schematic sectional view illustrating a sheet processing apparatus in which a protrusion plate in a folding unit is in an entered state according to embodiment 1.

As shown in FIG. 1, a sheet processing apparatus 110 of embodiment 1 is arranged on an image forming apparatus 100. The sheet processing apparatus 110 is connected with the image forming apparatus 100 in a communicable manner.

The image forming apparatus 100 is described first.

The image forming apparatus 100 has an image formation mode and a lamination mode as action modes. The image formation mode further includes a copy mode and a printer mode. The copy mode refers to an action mode of forming an image by reading the image of an original document with a scanner unit 2. The printer mode refers to an action mode of forming an image by receiving an external image signal through a communication line. The only difference between the copy mode and the printer mode is the difference in image signal sending sources, and the image formation actions based on an image signal are the same in the copy mode and the printer mode.

In the image formation mode, the image forming apparatus 100 forms an image on a sheet S with a toner. In the image formation mode, the image forming apparatus 100 discharges a sheet S on which an image is formed to a sheet processing apparatus 110 which is described later, and the sheet processing apparatus 110 discharges the sheet S to a sheet discharging tray 14 (sheet discharging unit) which is described later.

In the lamination mode, the image forming apparatus 100 forms an image on a sheet S, like in the image formation mode. In this case, the sheet processing apparatus 110 laminates the sheet S using a lamination film LF to form a lamination sheet LS. The sheet processing apparatus 110 discharges the lamination sheet to a lamination sheet discharging tray 16 which is described later.

The image forming apparatus 100 comprises a control panel 1, a scanner unit 2, a printer unit 3, a sheet feeding unit 4 and a main body control unit 9.

The control panel 1 is a part of an input unit for an operator to operate the image forming apparatus 100 and the sheet processing apparatus 110 and input information. The control panel 1 has a touch panel and various hard keys. The operator can input the start or the end of a lamination mode from the control panel 1.

To switch to the lamination mode from the printer mode, a mode switching control signal is sent via a communication line which is not shown in accompanying drawings. Once received by the image forming apparatus 100, the mode switching control signal is sent to the main body control unit 9 which is described later.

The scanner unit 2 reads the image information of a copied object as light intensity and outputs the read image information to the printer unit 3.

According to the image information received from the scanner unit 2 or from the outside, the printer unit 3 forms an output image (hereinafter referred to as a toner image) using a developing agent containing a toner.

The printer unit 3 transfers the toner image on the surface of a sheet S and applies heat and pressure to the toner image on the surface of the sheet S to fix the toner image on the sheet S.

The sheet feeding unit 4 feeds sheets S, one by one, to the printer unit 3 matching with the formation timing of toner images by the printer unit 3.

The sheet feeding unit 4 is provided with paper cassettes 40A and 40B. The paper cassette 40A is overlapped on the paper cassette 40B. Sheets are accommodated in the paper cassettes 40A and 40B. The sheets accommodated in the paper cassettes 40A and 40B may be of different sizes.

A paper feeding roller 40a (40b) is arranged in the paper cassette 40A (40B) to successively pick up sheets S from the paper cassette 40A (40B).

As FIG. 1 is a schematic diagram, the paper feeding roller 40a (40b) is simplified in FIG. 1. For example, the paper feeding roller 40a (40b) may include a plurality of rollers including a pickup roller and a separating roller.

Further, the sheet feeding unit 4 is provided with conveyance rollers 41a and 41b. The conveyance roller 41a conveys the sheet S picked up by the paper feeding roller 40a to the conveyance section 5 in the printer unit 3. The conveyance roller 41b conveys the sheet S picked up by the paper feeding roller 40b to the conveyance roller 41a. The conveyance roller 41a also conveys the sheet S conveyed from the conveyance roller 41b to the conveyance section 5.

It is exemplified in FIG. 1 that the sheet feeding unit 4 consists of the paper cassettes 40A and 40B. However, the sheet feeding unit 4 may comprise other paper cassettes. The sheet feeding unit 4 may further comprise a manual tray and a manual paper feeding unit.

Next, the detailed structure of the printer unit 3 is described below.

The printer unit 3 comprises a conveyance section 5, an image forming section 6, an exposure section 7 and a fixer 8.

The conveyance section 5 which conveys a sheet S at least comprises a resist roller 5a and a paper discharging roller 5b.

The resist roller 5a is positioned above the conveyance roller 41a. The resist roller 5a neatens the position of the front end of the sheet S and conveys the position-neatened sheet S.

A conveyance guiding plate is arranged between the resist roller 5a and the paper discharging roller 5b. The conveyance guiding plate guides the conveyance of the sheet S along a fixed conveyance path.

Observed from the resist roller 5a, the image forming section 6 and the fixer 8 are sequentially arranged along the conveyance path.

The image forming section 6 is provided with a photoconductive drum 6a which has a photoconductive layer on the surface of a metal drum. The image forming section 6 develops the electrostatic latent image formed on the photoconductive drum 6a using a toner.

A charger 6b, a developer 6c, a transfer roller 6d, a cleaning unit 6e and a destaticization device 6f, which are all currently known in the art, are arranged around the photoconductive drum 6a.

The charger 6b charges the photoconductive drum 6a. The developer 6c develops the electrostatic latent image on the photoconductive drum 6a. The transfer roller 6d is opposite to and propped against the photoconductive drum 6a. A transfer bias is applied to the transfer roller 6d. The transfer roller 6d transfers the toner image developed by the developer 6c onto a sheet S. The cleaning unit 6e erases the residual toner left on the photoconductive drum 6a and recycles the erased toner. The destaticization device 6f irradiates the photoconductive drum 6a with light so as to remove the charges of the photoconductive drum 6a.

The exposure section 7 is arranged above the image forming section 6.

The exposure section 7 irradiates the surface of the photoconductive drum 6a with exposure light which is modulated based on an image signal sent from the scanner unit 2 or the outside. The image signal sent from the scanner unit 2 or the outside to the exposure section 7 is corresponding to the image formed on a sheet S.

The exposure section 7 forms an electrostatic latent image on the photoconductive drum 6a according to the image signal. The position irradiated by the exposure light is between the charger 6b and the developer 6c.

For example, the exposure section 7 may be a structure employing a scanning laser beam. For example, the exposure section 7 may be a structure capable of implementing solid state scanning using an LED element.

The fixer 8 applies heat and pressure to the sheet S to fix the toner image transferred on the sheet S.

The fixer 8 conveys the sheet S on which the toner image is fixed to the paper discharging roller 5b. A sheet S on which a toner image is fixed is hereinafter referred to as an FS.

The paper discharging roller 5b discharges the FS conveyed from the fixer 8 to the sheet processing apparatus 110. In embodiment 1, as an example, the paper discharging roller 5b discharges the FS towards a horizontal direction.

The main body control unit 9 controls each unit of the foregoing image forming apparatus 100 to cause each unit to function.

Further, the main body control unit 9 is connected with the sheet processing apparatus 110 in a communicable manner to notify the sheet processing apparatus 110 of the action mode of the image forming apparatus 100.

Further, the main body control unit 9 notifies the sheet processing apparatus 110 to start to feed a sheet S. The main body control unit 9 notifies the sheet processing apparatus 110 of the size and the conveyance direction of the fed sheet S.

The main body control unit 9 notifies the sheet processing apparatus 110 to discharge an FS.

In the lamination mode, if the width of a front end adhesive part which is described later is input from the control panel 1, then the main body control unit 9 sends the input width value to the sheet processing apparatus 110.

The main body control unit 9 structurally consists of proper hardware and a computer equipped with a CPU, a memory, input/output interface and an external memory. The main body control unit 9 causes the computer to execute control programs, thereby realizing the foregoing control functions. Alternatively, the main body control unit 9 causes proper hardware to act, thereby realizing the foregoing control functions.

The structure of the sheet processing apparatus 110 is described.

As shown in FIG. 2 and FIG. 3, the sheet processing apparatus 110 comprises a first conveyance unit 10A, a paper discharging tray 14 (sheet discharging unit) and a second conveyance unit 10B. Further, the sheet processing apparatus 110 comprises a lamination film feeding unit 15 (hereinafter referred to as an LF feeding unit 15 for short), a third conveyance unit 11 and a locating component (locating unit) 17. Further, the sheet processing apparatus 110 comprises a folding unit 19. Further, the sheet processing apparatus 110 comprises a fourth conveyance unit 12, a lamination unit 13 and a lamination sheet discharging tray (hereinafter referred to as an LS discharging tray for short) 16. Further, the sheet processing apparatus 110 comprises a control unit 201.

The first conveyance unit 10A conveys the FS discharged from the image forming apparatus 100.

As shown in FIG. 2, the first conveyance unit 10A comprises a first roller 10a, a second roller 10b, a third roller 10c and a paper discharging roller 10d. The first roller 10a, the second roller 10b, the third roller 10c and the paper discharging roller 10d each consist of a pair of rollers. The pair of rollers clamps the FS.

The first roller 10a is opposite to the paper discharging roller 5b of the image forming apparatus 100. The first roller 10a conveys the FS which is discharged from the paper discharging roller 5b towards the horizontal direction. The conveyance direction based on the first roller 10a may be not the horizontal direction. In embodiment 1, as an example, the first roller 10a conveys an FS towards the horizontal direction.

The first roller 10a, the second roller 10b, the third roller 10c and the paper discharging roller 10d are sequentially and separately arranged. Conveyance guiding plates for guiding the conveyance of an FS are arranged among the first roller 10a, the second roller 10b, the third roller 10c and the paper discharging roller 10d.

The first roller 10a, the second roller 10b, the third roller 10c and the paper discharging roller 10d are connected with a drive motor (not shown) through a transmission mechanism (not shown). The first roller 10a, the second roller 10b, the third roller 10c and the paper discharging roller 10d convey an FS from the paper discharging roller 5b to a paper discharging tray 14 which is described later.

An entry sensor s1 is arranged between the first roller 10a and the second roller 10b to detect the arrival of an FS. The entry sensor s1 sends a detection signal to the control unit 201 which is described later.

The paper discharging tray 14 is arranged below the head of the conveyance direction of the paper discharging roller 10d. The paper discharging tray 14 accommodates the FS discharged by the paper discharging roller 10d.

The first roller 10a, the second roller 10b, the third roller 10c and the paper discharging roller 10d may be arranged at proper positions according to the position relationship between the paper discharging roller 5b and the paper discharging tray 14. As an example, the conveyance paths of the first roller 10a, the second roller 10b, the third roller 10c and the paper discharging roller 10d are on the same plane along the horizontal plane.

A flapper 10f is arranged between the second roller 10b and the third roller 10c.

The flapper 10f switches the conveyance paths between the second roller 10b and the third roller 10c. A flapper switching unit 23 is connected with the flapper 10f (refer to FIG. 3).

The flapper switching unit 23 causes the flapper 10f to advance or retreat with respect to the conveyance path between the second roller 10b and the third roller 10c. FIG. 2 shows a state in which the flapper 10f retreats from the conveyance path between the second roller 10b and the third roller 10c.

For example, as an example, the flapper switching unit 23 is a rotary or linear solenoid.

The flapper switching unit 23 is controlled by the control unit 201 which is described later.

When the flapper 10f retreats from the conveyance path between the second roller 10b and the third roller 10c, an FS is conveyed from the second roller 10b to the third roller 10c.

When the flapper 10f enters the conveyance path between the second roller 10b and the third roller 10c, an FS is bifurcated from the conveyance path between the second roller 10b and the third roller 10c. The flapper 10f guides the FS downwards.

The second conveyance unit 10B is located below the flapper 10f.

The second conveyance unit 10B comprises a fourth roller 10e and a conveyance guiding plate 10g.

The fourth roller 10e below the flapper 10f consists of a pair of rollers which clamp an FS. The fourth roller 10e, like the first roller 10a, is connected with a drive motor (not shown) through a transmission mechanism (not shown).

The fourth roller 10e conveys the FS guided by the flapper 10f downwards. As an example, in the sheet processing apparatus 110, the fourth roller 10e guides an FS down along a vertical plane.

The conveyance guiding plate 10g is arranged below the fourth roller 10e to guide the conveyance of an FS along a vertical plane.

An entry sensor s2 is arranged on the conveyance guiding plate 10g to detect the entry of an FS into the conveyance guiding plate 10g. The entry sensor s2 sends a detection signal to the control unit 201 which is described later.

The LF feeding unit 15 feeds an LF. The LF feeding unit 15 comprises a lamination film feeding tray 15a (hereinafter referred to as an LF feeding tray 15a for short) and a lamination film feeding roller 15b (hereinafter referred to as an LF feeding roller 15b for short).

The LF feeding tray 15a stacks lamination films.

Here, the LF used in the sheet processing apparatus 110 is described.

The LF is a rectangular cut sheet. The LF can be made from any material that enables the lamination of the FS, and no specific limitation is given to the material of the LF.

The LF is a multi-layer film comprising a base film and a thermoplastic resin layer. The base film is made from a material which is not melted even if heated during a lamination process. For example, as an example, the base film is a polyethylene terephthalate (PET) film. The thermoplastic resin layer is melted or softened when heated during a lamination process. As melted or softened when heated, the thermoplastic resin layer has an adhesive effect.

The size of the LF is set so that the folded LF can clamp a laminated FS therein. The length of the FS in an FS conveyance direction is set to be L, and the width of the FS in the direction vertical to the FS conveyance direction is set to be W. In this case, the length of the LF in the LF conveyance direction is 2(L+ΔL), and the width of the LF in the direction vertical to the LF conveyance direction is 2(W+ΔW).

As stated below, the sheet processing apparatus 110 folds an LS in half. There is no need to preset a fold line on the LF for folding an LS in half. However, if an LF can be conveyed while being opened and folded in half, then a fold line can be set on the LF.

Sometimes, the length of the FS/LF in the conveyance direction of the FS/LF is hereinafter referred to the length of the FS/LF for short. Further, the width of the FS/LF in the direction vertical to the conveyance direction of the FS/LF is sometimes hereinafter called the width of the FS/LF for short. Sometimes, the direction in which the length or width of the FS/LF is measured is called the length or width direction of the FS/LF.

ΔL and ΔW are the sum of the overlapped areas of LFs (hereinafter referred to as an overlapped area) on the periphery of the FS. The overlapped areas are mutually adhered during a lamination process.

In the sheet processing apparatus 110, an FS and an LF are conveyed with the center of the FS in an FS width direction aligned with that of the LF in an LF width direction. Thus, the overlapped areas at two ends of the width direction are equally divided into ΔW/2.

As stated below, the sheet processing apparatus 110 is capable of changing the size of the overlapped area in the length direction through the front end and the rear end of the FS.

ΔL and ΔW may be proper values above 0 mm. However, if the adhesion property of the laminated LF and FS is not good, then it is preferred that ΔL is greater than 0 (mm) and ΔW is greater than 0 (mm). For example, ΔL and ΔW may be above 6 mm. When ΔL and ΔW may be above 6 mm, LFs are adhered firmly, which practically preventing the peeling of the LF from the FS.

The LF is placed on the LF feeding tray 15a with the front end thereof in the length direction serving as a leading head. The operator places the LF on the LF feeding tray 15a with the base film of the LF facing down and the thermoplastic resin layer of the LF facing up.

The LF feeding unit 15 is provided with the LF feeding roller 15b which is arranged above the front end of stacked LFs in the length direction of the LFs.

The LF feeding roller 15b takes LFs, one by one, from the LF feeding tray 15a.

The LF feeding roller 15b may have the same structure with the paper feeding roller 40a of the image forming apparatus 100. However, the LF feeding roller 15b has a frictional performance by means of which the LF feeding roller 15b is capable of separating LFs one by one.

The third conveyance unit 11 conveys the LF fed from the LF feeding roller 15b. The third conveyance unit 11 moves the LF to a position intersecting with the FS conveyance path of the second conveyance unit 10B.

The third conveyance unit 11 is provided with a lamination film conveyance roller 11a (hereinafter referred to as an LF conveyance roller 11a for short), a first press roller 11b and a second press roller 11c. The LF conveyance roller 11a, the first press roller 11b and the second press roller 11c each consist of a pair of rollers. Each pair of opposite pairs clamp an LF.

The LF conveyance roller 11a is opposite to the LF feeding roller 15b. The LF conveyance roller 11a conveys the LF fed from the LF feeding section 15. The conveyance direction of the LF conveyance roller 11a may not be the horizontal direction. In the first embodiment, as an example, the LF conveyance roller 11a conveys an FS towards the horizontal direction.

The third conveyance unit 11 is located below the first conveyance unit 10A and the second conveyance unit 10B.

The LF conveyance roller 11a, the first press roller 11b and the second press roller 11c are sequentially and separately arranged. Conveyance guiding plates for guiding the conveyance of an LF are arranged between the LF feeding roller 15b, the first press roller 11b and the second press roller 11c.

As shown in FIG. 4A, the conveyance path PLF in the third conveyance unit 11 is intersected with the FS conveyance path PFS of the second conveyance unit 10B.

In FIG. 4A and FIG. 4B, the centers of the conveyance paths PLF and PFS in a width direction are presented by dotted lines.

The conveyance path PLF is intersected with the conveyance path PFS between the first press roller 11b and the second press roller 11c. The first press roller 11b and the second press roller 11c are opposite to each other cross the conveyance path PFS.

Conveyance guiding plates 11d and 11e for guiding the lower part of an LF down are arranged between the first press roller 11b and the second press roller 11c.

The conveyance guiding plates 11d and 11e are opposite to each other cross the conveyance path PFS. Deformation guiding sections 11g and 11h (deformation guiding plates) serving as the opposite front ends of the conveyance guiding plates 11d and 11e are curved downwards. The deformation guiding sections 11g and 11h guide the deformation of an LF during an LF folding process which is described later.

The front ends of the deformation guiding sections 11g and 11h are separated from each other. A slit 11f is formed between the deformation guiding sections 11g and 11h.

The LF conveyance roller 11a, the first press roller 11b and the second press roller 11c are connected with a drive motor (not shown) by a transmission mechanism (not shown).

The LF conveyance roller 11a, the first press roller 11b and the second press roller 11c convey an LF from the LF feeding roller 15b towards the locating component 17 which is described later.

The first press roller 11b and the second press roller 11c can be switched between a restrained state and an unrestrained state.

Here, the restrained state refers to a state in which an LF is linked with the rotation of the first press roller 11b (the second press roller 11c). In the restrained state, the position of an LF is fixed when the first press roller 11b (second press roller 11c) is not rotating.

The unrestrained state refers to a state in which the restraint to an LF is released. When in the unrestrained state, an LF may advance or retreat in a conveyance direction when applied with an external force.

The restrained state and the unrestrained state can be switched by, for example, setting a clutch for the transmission mechanism (not shown). Alternatively, in the first press roller 11b (second press roller 11c), the restrained state and the unrestrained state can be switched by changing the distance between the shafts of a pair of rollers. In embodiment 1, as an example, the transmission mechanism (not shown) is equipped with a clutch. The actions of each clutch are controlled by the control unit 201 which is described later.

As shown in FIG. 2, the locating component 17 locates the front end of an LF conveyed by the third conveyance unit 11.

The locating component 17 comprises a stopper 17a, a slider 17b and a locating component sensor s3.

The stopper 17a limits the position of the front end of an LF.

The slider 17b makes the stopper 17a supported in an LF conveyance direction in such a manner the stopper 17a can advance or retreat in LF the conveyance direction. The slider 17b is moved by a locating component drive unit 18 which is controlled by the control unit 201 which is described later.

The locating component sensor s3 detects the position of the front end of an LF facing the stopper 17a and outputs the result of the detection to the control unit 201 which is described later.

The folding unit 19 folds an LF located on the locating component 17 to form, on the LF, a groove having a V-shaped section.

The folding unit 19 is provided with a protrusion plate 21 and a folding roller 20 (a roller pair).

The width of the protrusion plate 21 in the depth direction of FIG. 4A and FIG. 4B is equivalent to that of an LF.

As shown in FIG. 4A and FIG. 4B, the protrusion plate 21 is arranged on one side of the conveyance guiding plate 10g. The protrusion plate 21 is inserted into an opening 10h arranged on the conveyance guiding plate 10g. The protrusion plate 21 is substantially parallel to the conveyance path PFS.

The front end 21a of the protrusion plate 21 is linear in a direction vertical to an LF conveyance plane (the vertical direction of FIG. 4A and FIG. 4B).

The base end of the protrusion plate 21 is connected with a protrusion plate drive unit 22 which causes the protrusion plate 21 to advance or retreat along the conveyance path PFS. No specific limitations are given to the structure of the protrusion plate drive unit 22. For example, the protrusion plate drive unit 22 comprises a single-shaft drive mechanism and a transmission mechanism for transmitting the drive force of the single-shaft drive mechanism. The single-shaft drive mechanism is, for example, a linear solenoid. The drive transmission mechanism is, for example; a cam or a link.

The protrusion plate drive unit 22 is controlled by the control unit 201 which is described later.

FIG. 4A shows a state in which the protrusion plate 21 retreats to the backmost position. When the protrusion plate 21 is in a retreated state, the front end 21a of the protrusion plate 21 is above the conveyance path PLF; and observed from a lateral side of the conveyance guiding plate 10g, the protrusion plate 21 blocks the opening 10h.

The side of the protrusion plate 21 facing the conveyance path PFS is separated from the conveyance path PFS.

Thus, when the protrusion plate 21 is in the retreated state, an FS can be conveyed in the conveyance path PFS without being contacted with the protrusion plate 21. When an FS is about to separate from the conveyance path PFS, like the conveyance guiding plate 10g, the protrusion plate 21 in the retreated state guides the conveyance of the FS.

Further, when the protrusion plate 21 is in the retreated state, an LF can be conveyed in the conveyance path PLF without being contacted with the protrusion plate 21.

FIG. 4B illustrates a state in which the protrusion plate 21 is inserted to the deepest position. When the protrusion plate 21 is in inserted state, the front end 21a of the protrusion plate 21 is nearby the nip Nd of a folding roller 20 which is described later. The protrusion plate 21 is intersected with the conveyance path PLF. The front end 21a of the protrusion plate 21 is located on the conveyance path PFS.

It is assumed that an LF is conveyed between the first press roller 11b and the second press roller 11c. In this case, when the protrusion plate 21 is in the inserted state, the LF is pressed by the front end 21a of the protrusion plate 21 towards the nip Nd of the folding roller 20 which is described later.

As shown in FIG. 4A, the folding roller 20 comprises opposite press rollers 20a and 20b. The press roller 20a is closer to the first press roller 11b than the conveyance path PFS. The press roller 20b is closer to the second press roller 11c than the conveyance path PFS.

For example, the press rollers 20a and 20b consist of rubber rollers. The press rollers 20a and 20b press each other through a pressure spring (not shown). A nip Nd is formed on the propped parts of the press rollers 20a and 20b.

The press rollers 20a and 20b are capable of clamping a sheet at the nip Nd. The clamped sheet can be conveyed if the press rollers 20a and 20b rotate while clamping the sheet therebetween.

The folding roller 20 is capable of clamping an FS clamped by the folded LF and pressurizing the clamped sheet through the nip Nd.

The press rollers 20a and 20b are located below the conveyance guiding plates 11d and 11e. The nip Nd is in the same plane with the conveyance path PFS. The rotation axes of the press rollers 20a and 20b are vertical to the FS conveyance direction in the conveyance path PFS.

If the press rollers 20a and 20b are observed from above through the slit 11f, then the nip Nd is in the center of the slit 11f. A recess 20c is formed by the surfaces of the press rollers 20a and 20b between the nip Nd and the slit 11f. The recess 20c is opened upwards. The section of the recess 20c vertical to the nip Nd is V-shaped.

The press rollers 20a and 20b are connected with a folding roller drive motor 24 (refer to FIG. 3) via a transmission mechanism (not shown).

The folding roller drive motor 24 rotates the press rollers 20a and 20b in inverse directions at the same linear speed. The folding roller drive motor 24 can rotate continuously or rotate a given rotation angle and can change the rotation direction thereof.

The folding roller drive motor 24 is connected with the control unit 201 which is described later in a communicable manner. The folding roller drive motor 24 is controlled by the control unit 201.

The folding roller drive motor 24 is, for example, a step motor.

If the press rollers 20a and 20b are rotated by the folding roller drive motor 24, then the sheet clamped by the nip Nd is conveyed.

In the sheet pressurized by the nip Nd, the LF is adhered to the FS. The foregoing sheet which is conveyed to a position below the folding roller 20 through the nip Nd is hereinafter referred to as a stacked sheet SS.

As shown in FIG. 2, the fourth conveyance unit 12 is located below the folding roller 20.

The fourth conveyance unit 12 conveys an SS which is conveyed down from the folding roller 20 to the lamination unit 13 which is described later.

The fourth conveyance unit 12 comprises a first roller 12a and a second roller 12b which both consist of a pair of rollers. The SS conveyed from the folding roller 20 is clamped by the pair of rollers.

The first roller 12a and the second roller 12b are sequentially configured in the direction from the folding roller 20 to the lamination unit 13. Conveyance guiding plates for guiding the conveyance of an SS are arranged between the folding roller 20, the first roller 12a, the second roller 12b and the lamination unit 13.

The first roller 12a and the second roller 12b are connected with a drive motor (not shown) via a transmission mechanism (not shown).

The first roller 12a and the second roller 12b are controlled by the control unit 201.

The lamination unit 13 carries out a lamination processing by heating and pressurizing the SS conveyed by the fourth conveyance unit 12.

The lamination unit 13 is equipped with heating rollers 13a and 13b. The conditions on the heating temperature and the pressurizing force of the heating rollers 13a and 13b are properly set in advance according to the characteristics of an LF.

For example, ordinarily, an LF can be laminated well if heated at 130-140 degrees centigrade. On the other hand, the toner used in the image forming apparatus 100 is usually fixed at about 180 degrees centigrade.

In this case, as the heating temperature in the lamination unit 13 is lower than the fixation temperature, in the lamination unit 13, the toner image on an FS is not softened again, leading to no change in the toner image.

The thermoplastic resin layer of an LF is melted or softened in the SS when an SS passes the lamination unit 13. If the SS is taken out of the lamination unit 13 and cooled, then the LF, the FS and the LF are mutually adhered. The adhered SS is hereinafter referred to as an LS.

If the SS is output from the lamination unit 13, then the SS is referred to as an LS.

The LS output from the lamination unit 13 is held in the LS discharging tray 16. The LS discharging tray 16 may be arranged at a fixed position. The position of the LS discharging tray 16 may be lowered according to the quantity of the LSs held in the LS discharging tray 16.

As shown in FIG. 3, the control unit 201 is connected with each part of the sheet processing apparatus 110 and the main body control unit 9 of the image forming apparatus 100 in a communicable manner. The control unit 201 controls each part of the sheet processing apparatus 110 based on a control signal sent from the main body control unit 9.

The detailed control processing of the control unit 201 and the actions of the sheet processing apparatus 110 are described together below.

The control unit 201 structurally consists of proper hardware and a computer equipped with a CPU, a memory, input/output interfaces and an external memory. The control unit 201 enables the computer to execute control programs to realize the control functions which are described later. Alternatively, the control unit 201 enables proper hardware to act to realize the control functions which are described later.

The actions of the image forming apparatus 100 with the foregoing structure and the sheet processing apparatus 110 with the foregoing structure are described below around the lamination processing of the sheet processing apparatus 110.

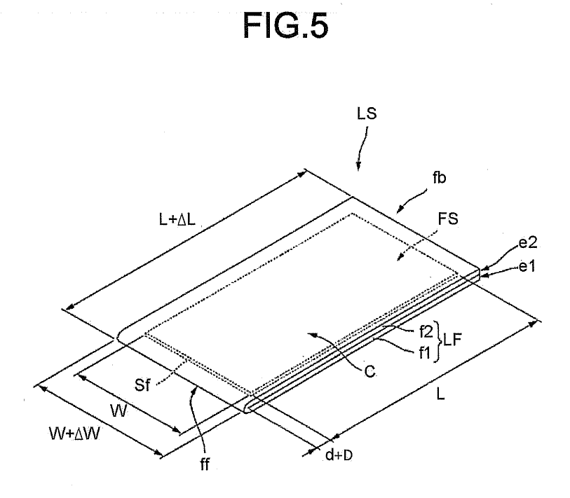

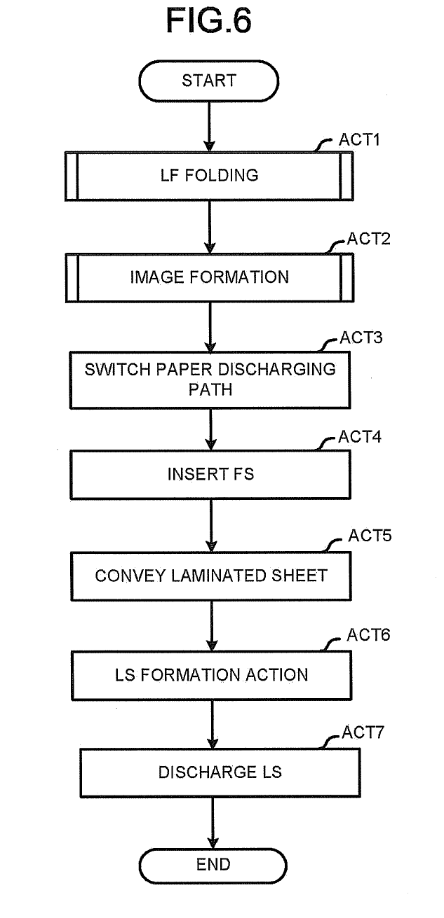

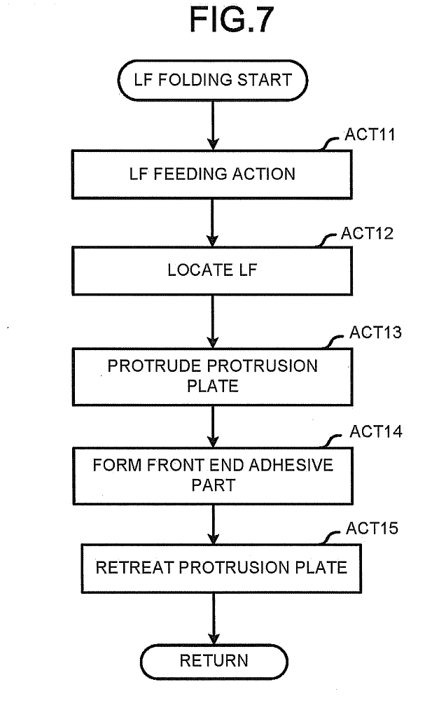

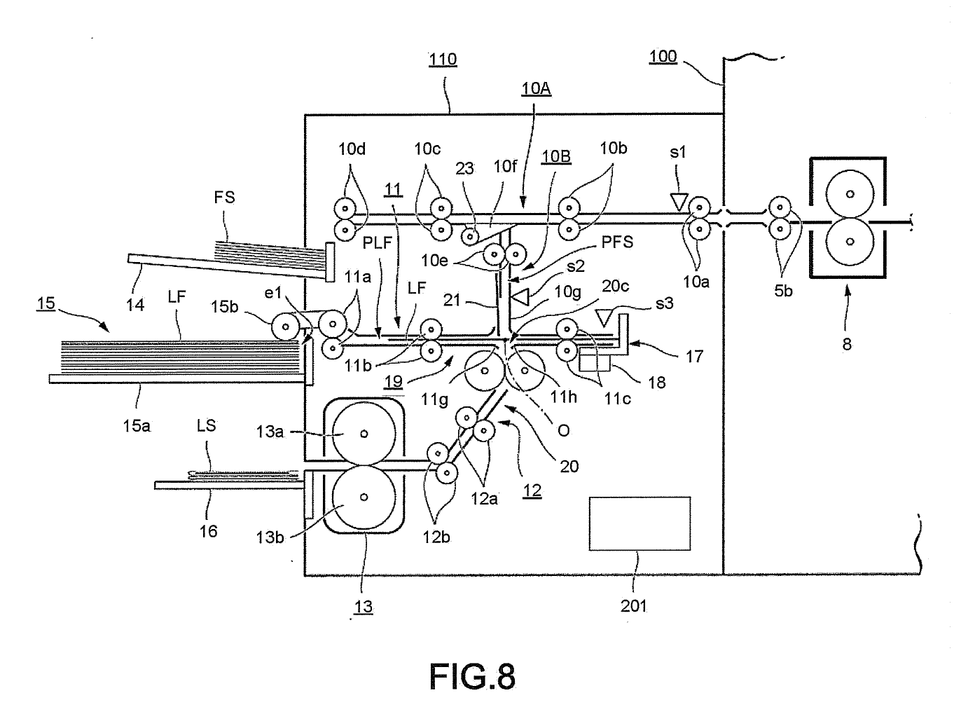

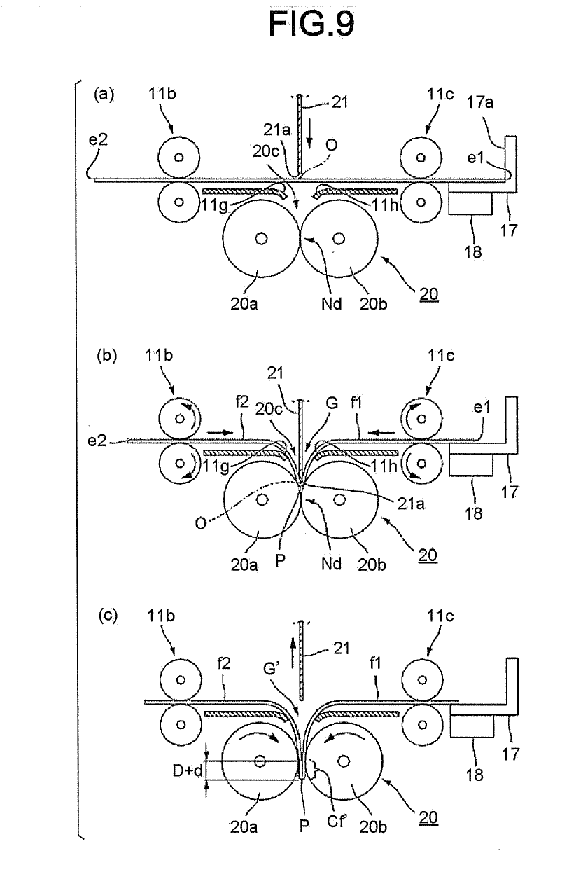

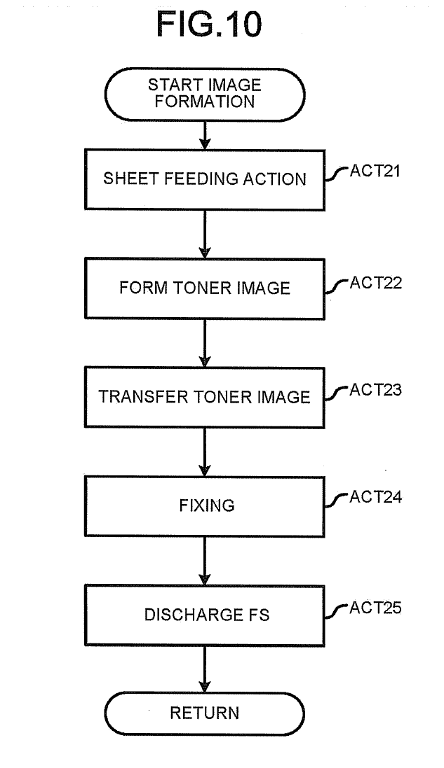

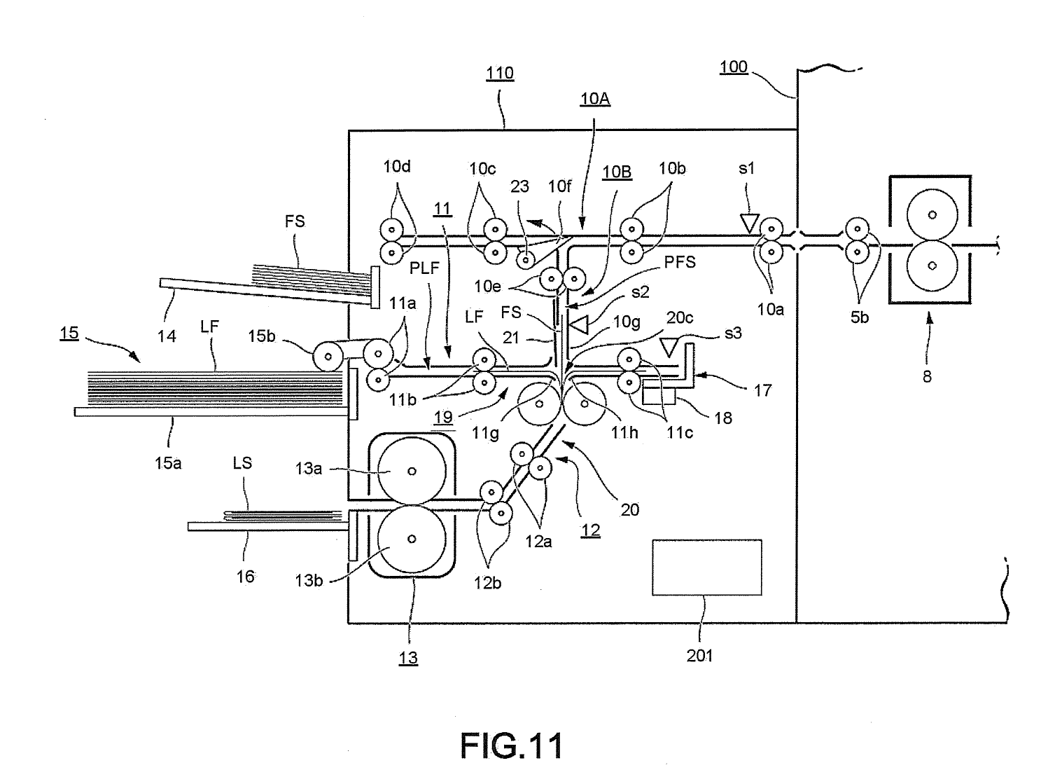

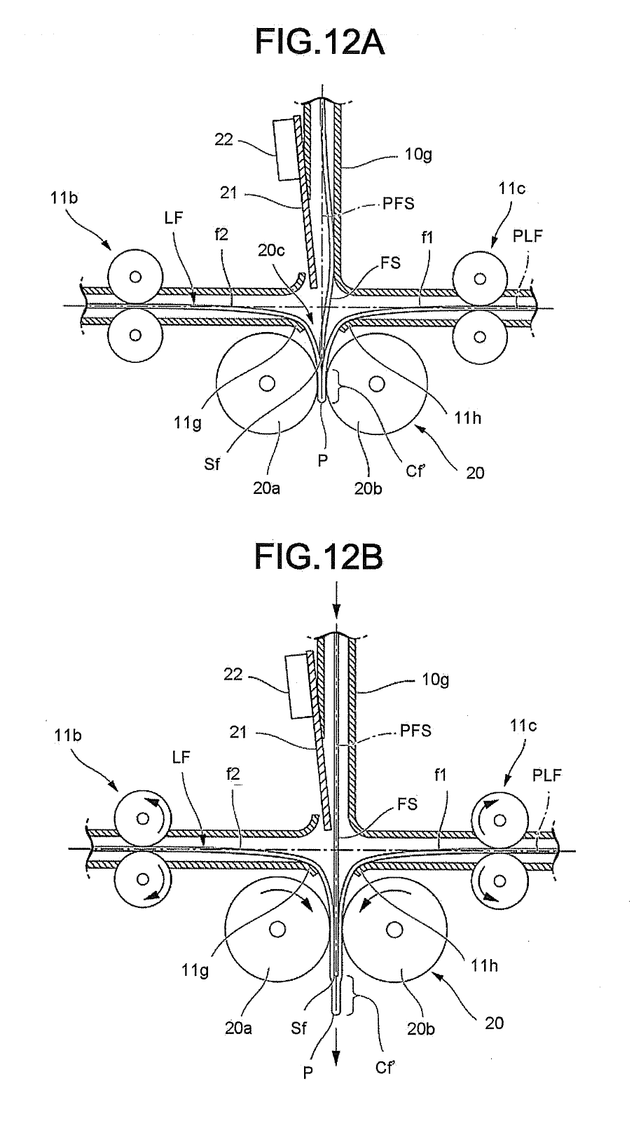

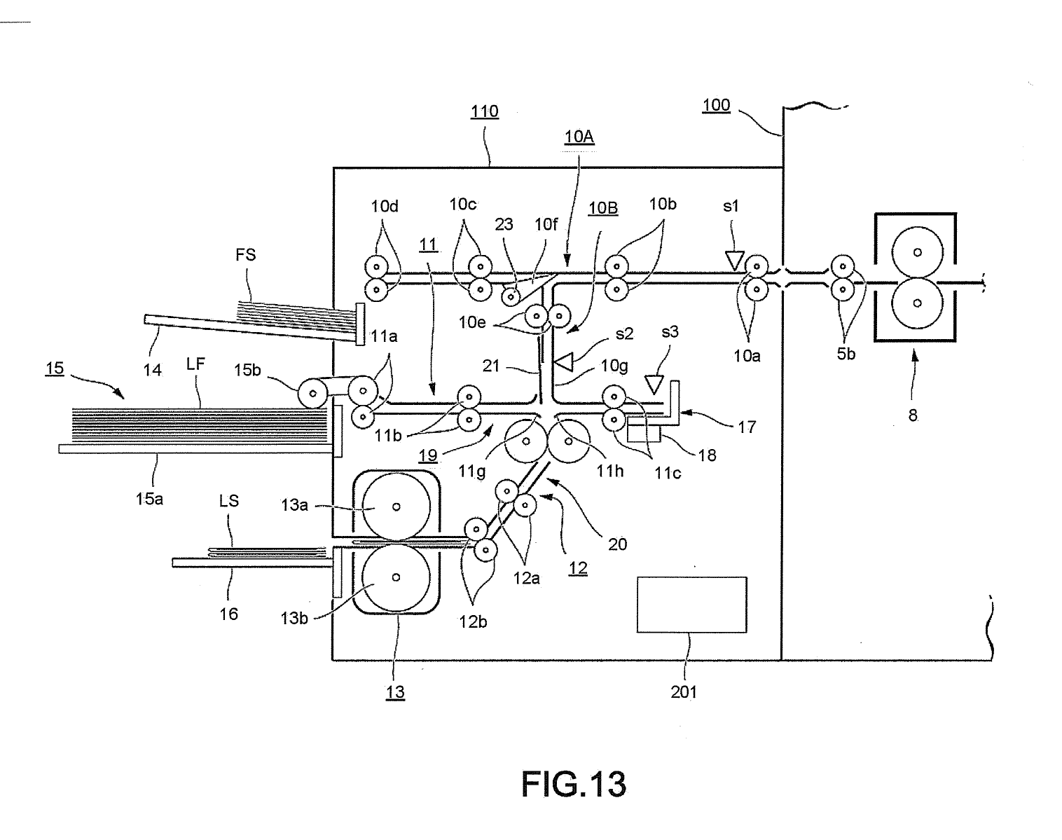

FIG. 5 is a three-dimensional schematic diagram exemplifying a lamination sheet formed by a sheet processing apparatus according to embodiment 1. FIG. 6 is a flowchart illustrating the flow of a lamination method using a sheet processing apparatus according to embodiment 1. FIG. 7 is a flowchart illustrating the flow of a lamination film folding action implemented in a sheet processing apparatus according to embodiment 1. FIG. 8 is a schematic sectional view illustrating the actions of a sheet processing apparatus according to embodiment 1. FIG. 9 is a schematic sectional view illustrating a location action and a folding action based on a sheet processing apparatus according to embodiment 1. FIG. 10 is a flowchart illustrating the flow of an image formation action implemented in a sheet processing apparatus according to embodiment 1. FIG. 11 is a schematic sectional view illustrating the actions of a sheet processing apparatus according to embodiment 1. FIG. 12A and FIG. 12B are schematic sectional diagrams illustrating the actions implemented in a folding unit of a sheet processing apparatus according to embodiment 1. FIG. 13 is a schematic sectional view illustrating the actions of a sheet processing apparatus according to embodiment 1.

When the sheet processing apparatus 110 carries out a lamination processing, the action mode of the image forming apparatus 100 is set to be a lamination mode. The action mode switched to may also be a copy mode or a printer mode.

As an example, the lamination action in a copy mode is described below.

The operator operates the control panel 1 to set the action mode of the image forming apparatus 100 to be a lamination mode. Further, the operator places an original document for the scanner unit 2.

The operator sets image formation action conditions from the control panel 1 as needed, for example, the operator sets printing numbers and a paper cassette for feeding sheets S. If the image formation action conditions are not set by the operator, then related defaulted values or automatically detected values are adopted. For example, in a case where ‘select paper automatically’ is valid, after an original document is read by the scanner unit 2, a sheet S matching in size with the original document is selected from a proper paper cassette.

Further, the operator can input an adjustment value to adjust the width of the front end adhesive part of the LS.

The front end adhesive part of the LS is described here.

FIG. 5 shows an example an LS formed by the sheet processing apparatus 110. The LS clamps an FS between a folded LF. The shape of the FS is a rectangle having a length L and a width W. The length of the LF is 2(L+ΔL), and the width of the LF is (W+ΔW). The LF is folded in half along the central axis in the length direction of the LF. Taking the folded central axis as a boundary, the LF includes a first part f1 the area of which is (L+ΔL)×(W+ΔW) and a second part f2. The end of the first part f1 opposite to the second part f2 is a first end e1 of the LF in the length direction of the LF. The end of the second part f2 opposite to the first part f1 is a second end e2 of the LF in the length direction of the LF.

In the LS, the FS is clamped between the first part f1 and the second part f2. The FS is clamped in the center of the first part f1 and the second part f2.

The front end Sf of the FS in the conveyance direction of the FS faces the front ends ff of the folded LS. As stated below, the LS is discharged from the lamination unit 13 with the front end ff serving as a leading head.

The end of the LS opposite to the front end ff is a rear end fb. The first end e1 and the second end e2 of the LF are located on the rear end fb.

In the LS, an adhered part C where the first part f1 and the second part f2 are mutually adhered is formed outside the periphery of the FS.

The adhered part C between the front end Sf of the FS and the front end ff of the LS is hereinafter referred to as a front end adhesive part Cf.

The width of the front end adhesive part Cf is d+D (D≧−d). The width d is a width formed by the sheet processing apparatus 110 by default. The width D can be changed through an input operation of the operator. The width D which is based on the size of the FS can be changed automatically by the control unit 201.

In the copy mode, an operator presses a start key on the control panel 1 to start a lamination mode.

The image forming apparatus 100 and the sheet processing apparatus 110 carry out the actions of the lamination mode based on the flow shown in FIG. 6.

In Act 1, the main body control unit 9 of the image forming apparatus 100 notifies the control unit 201 of the sheet processing apparatus 110 of a lamination mode. Further, the main body control unit 9 notifies the control unit 201 of the size and the conveyance direction of a sheet S on which an image is formed.

After receiving the notification, the control unit 201 carries out a lamination film folding action (hereinafter referred to as an LS folding action for short). The sheet processing apparatus 110 carries out an LF folding action according to the flow shown in FIG. 7.

In Act 11, the sheet processing apparatus 110 conveys an LF fed from the paper feeding tray 15a to the inside thereof.

The control unit 201 controls the LF feeding unit 15 and the third conveyance unit 11 to convey the LF. As shown in FIG. 8, LFs are stacked on the LF feeding tray 15a of the LF feeding unit 15. The LF is stacked on the LF feeding tray 15a with the first end e1 thereof as a leading head. The LF is stacked on the LF feeding tray 15a with the base film thereof facing down.

The LF feeding unit 15 picks up LFs one by one from the LF feeding tray 15a using the LF feeding roller 15b. The LF is moved towards the LF conveyance roller 11a.

The LF conveyance roller 11a conveys the LF along the conveyance path PLF. At this time, the control unit 201 causes the protrusion plate 21 to enter a retreated state through the protrusion plate drive unit 22. Further, the control unit 201 causes the first press roller 11b and the second press roller 11c to enter a retrained state. For example, the control unit 201 opens the clutch of a transmission mechanism (not shown) connected with the first press roller 11b and the second press roller 11c. The first press roller 11b and the second press roller 11c are linked with a drive motor (not shown).

Under the drive of the LF conveyance roller 11a, the LF is advanced along the conveyance path PLF. After arriving at the first press roller 11b, the LF is clamped by the first press roller 11b and conveyed with the first press roller 11b towards the same direction. Further, after arriving at the second press roller 11c, the LF is clamped by the second press roller 11c and conveyed with the second press roller 11c towards the same direction.

When located on the recess 20c, the LF is more or less curved downwards under the effect of gravity. However, because of the certain rigidity thereof, the LF is held on a front deformation guide unit 11h but not falls into the slit 11f.

If the first end e1 of the LF passes the second press roller 11c, then the LF is horizontally stretched on the recess 20c.

If the LF is output from the LF feeding tray 15a and conveyed on the conveyance path PLF, then Act 11 is ended.

The sheet processing apparatus 110 executes Act 12 after executing Act 11.

In Act 12, the sheet processing apparatus 110 locates the LF.

After the LF passes the second press roller 11c, the control unit 201 controls the locating component drive unit 18 to align the position of the locating component 17.

The locating component drive unit 18 aligns the position of the locating component 17 to make the distance between the stopper 17a and the conveyance path PFS equal to half the length of the LF. The control unit 201 is notified of the length of the LF held on the LF feeding unit 15 in advance.

The control unit 201 can be notified in various ways. For example, the operator can input the length of the LF held on the LF feeding unit 15 from the control panel 1. In this case, the main body control unit 9 notifies the control unit 201 of the input length. For example, a size detection sensor may be arranged in the sheet processing apparatus 110 to detect the size of an LF. In this case, the size detection sensor detects the length of an LF. The size detection sensor notifies the control unit 201 of the length of the LF. The size detection sensor may also be arranged on the LF feeding unit 15. Alternatively, the size detection sensor is arranged on the third conveyance unit 11.

The control unit 201 controls the third conveyance unit 11 to convey the LF further in the conveyance path PLF. If the first end e1 of the LF arrives at the detection position of the locating component sensor s3, then the locating component sensor s3 sends a detection signal to the control unit 201.

After receiving the detection signal from the locating component sensor s3, the control unit 201 stops the conveyance of the third conveyance unit 11 after a given time. Here, the given time refers to that the time needed by the LF to move the distance between the detection position of the locating component sensor s3 and the stopper 17a.

After the third conveyance unit 11 is stopped, the first end e1 of the LF is propped against the stopper 17a. At this time, the central axis O of the LF in a length direction is on the conveyance path PFS (refer to FIG. 8).

Then, Act 12 is ended.

The sheet processing apparatus 110 executes Act 13 after executing Act 12.

In Act 13, the sheet processing apparatus 110 protrudes the protrusion plate 21.

The control unit 201 causes the first press roller 11b and the second press roller 11c to enter an unrestrained state before protruding the protrusion plate 21. For example, the control unit 201 opens the clutch of a transmission mechanism (not shown) connected with the first press roller 11b and the second press roller 11c. The first press roller 11b and the second press roller 11c are not driven by a drive motor (not shown). The first press roller 11b and the second press roller 11c are capable of rotating freely.

Then, the control unit 201 controls the protrusion plate drive unit 22 to enable the entry of the protrusion plate 21. As shown in FIG. 9(a), the protrusion plate 21 advances towards the nip Nd of the folding roller 20.

The front end 21a of the protrusion plate 21 is propped against the LF at the position where the protrusion plate 21 intersects with the conveyance path PLF. The front end 21a of the protrusion plate 21 is propped against the central axis O of the LF in a length direction.

Further, the advancing protrusion plate 21 presses the LF downwards, as shown in FIG. 9(b). The first press roller 11b and the second press roller 11c are in an unrestrained state. Thus, the LF and the protrusion plate 21 descend together in the recess 20c. The LF is stretched into a V shape in the recess 20c. The deformation guiding sections 11g and 11h guide the deformation of the LF which is pressed in from below.

If the protrusion plate 21 passes the slit 11f, then the LF enters the slit 11f.

If the protrusion plate 21 enters an entry position, then the protrusion plate 21 presses the LF to a position nearby the nip Nd of the folding roller 20. The central part of the LF is clamped between the protrusion plate 21 and the nip Nd. Further, the central part of the LF is curved into a V shape along the surfaces of the press rollers 20a and 20b. A groove G which is opened upwards is formed in the center of the LF. The section of the groove G is V-shaped along the recess 20c and the deformation guiding sections 11g and 11h.

By taking the folding line P based on the protrusion plate 21 as the border, the part of the LF nearby the second press roller 11c forms a first part f1, and the part of the LF nearby the first press roller 11b forms a second part f2.

In this way, the folding unit 19 folds the LF located by the locating component 17 in Act 13. The folding unit 19 forms a groove G in the center of the LF. The groove G has a V-shaped section.

Then, Act 13 is ended.

The sheet processing apparatus 110 executes Acts 14 and 15 after executing Act 13.

In Act 14, the sheet processing apparatus 110 forms a front end adhesive part Cf′.

As shown in FIG. 9(c), the control unit 201 drives the folding roller drive motor 24 to pull the LF to the nip Nd. The folding roller drive motor 24 rotates the press roller 20a along the clockwise direction shown in FIG. 9(c) and the press roller 20b along the anticlockwise direction shown in FIG. 9(c).

The folding line P of the LF is clamped by the press rollers 20a and 20b. Then, the LF is moved with the press rollers 20a and 20b with the folding line P serving as a leading head. The press roller 20a conveys the second part f2 of the LF down. The press roller 20b conveys the first part f1 of the LF down.

The first part f1 and the second part f2 are clamped by the folding roller 20 in the nip Nd. The folding roller 20 pressurizes the first part f1 and the second part f2 clamped in the nip Nd.

In this way, the folding roller 20 forms a front end adhesive part Cf′ on the LF from the folding line P to the nip Nd. The first part f1 is adhered to the second part f2 in the front end adhesive part Cf′. The front end adhesive part Cf′ is a part constituting the front end adhesive part Cf of the LS in the lamination process which is described later.

The width of the front end adhesive part Cf′ in the conveyance direction is changed by changing the amount of the rotation of the folding roller 20. The folding roller drive motor 24 is stopped when the width of the front end adhesive part Cf′ is changed to d+D by rotating the folding roller 20 through the control unit 201.

In this case, the LF above the front end adhesive part Cf′ is propped against the press rollers 20a and 20b and the deformation guiding sections 11g and 11h. A groove G′ which is the same as the groove G is formed on the LF located above the front end adhesive part Cf′.

Then, Act 14 is ended.

The sheet processing apparatus 110 executes Act 15 after the folding line P is clamped by the press rollers 20a and 20b in Act 14. Act 15 may be executed in the process of Act 14 or after Act 14.

The sheet processing apparatus 110 causes the protrusion plate 21 to enter a retreated state in Act 15.

If the folding line P of the LF is clamped in the nip Nd, then the groove G′ is formed even in the absence of the entry of the protrusion plate 21.

Here, the control unit 201 controls the protrusion plate drive unit 22 to cause the protrusion plate 21 to enter a retreated state.

Then, Act 15 is ended.

LF folding action Act 1 is ended if Acts 14 and 15 are both ended. If Act 1 is ended, then the control unit 201 notifies the main body control unit 9 of the end of the LF folding action.

As shown in FIG. 6, Act 2 is executed after Act 1 is ended.

In Act 2, the image forming apparatus 100 forms an image on the sheet S.

In Act 2, the image forming apparatus 100 carries out the following actions according to the flow shown in FIG. 10.

In Act 21, the image forming apparatus 100 feeds a sheet S from the sheet feeding unit 4.

The main body control unit 9 receives the notification on the end of the LF folding action from the control unit 201, causes the sheet feeding unit 4 and the conveyance section 5 to carry out a sheet feeding action and a conveyance action, and notifies the control unit 201 of the start of the feeding of a sheet S.

The sheet feeding unit 4 feeds a sheet S designated by the operator or a sheet S the size of which is detected by the scanner unit 2. For example, the sheet feeding unit 4 feeds a sheet S fed from the paper cassette 40A by the paper feeding roller 40a. The sheet feeding unit 4 feeds the sheet S to the conveyance section 5 through the conveyance roller 41a. The sheet S arrives at the resist roller 5a. The front end of the sheet S is aligned with the nip N.

After receiving the notification on the start of the feeding of the sheet S from the main body control unit 9, the control unit 201 starts to drive the first conveyance unit 10A.

Then, Act 21 is ended.

The image forming apparatus 100 executes Act 22 after executing Act 21.

In Act 22, the image forming apparatus 100 forms a toner image.

The main body control unit 9 starts the image formation in an image forming section 6 after the front end of the sheet S is aligned with the nip N.

The image forming section 6 rotates the photoconductive drum 6a. The charger 6b charges the surface of the photoconductive drum 6a. The exposure unit 7 irradiates the surface of the photoconductive drum 6a with exposure light modulated based on an image signal. The charges of the part exposed by the exposure light are removed according to the quantity of illumination. An electrostatic latent image based on an image signal is formed on the surface of the photoconductive drum 6a.

The developer 6c develops the electrostatic latent image using a toner to form a toner image on the surface of the photoconductive drum 6a using the toner.

Then, Act 22 is ended.

The image forming apparatus 100 executes Act 23 after executing Act 22.

In Act 23, the image forming apparatus 100 transfers the toner image onto a sheet S.

The main body control unit 9 drives the resist roller 5a to convey the sheet S. The resist roller 5a is driven when the sheet S arrives at the transfer position of the transfer roller 6d while the toner image arrives at the transfer position of the transfer roller 6d.

If the sheet S reaches the transfer position, the main body control unit 9 applies a transfer bias to the transfer roller 6d. The transfer roller 6d transfers the toner image on the photoconductive drum 6a onto the sheet S.

If the sheet S passes the transfer position, then the toner image on the photoconductive drum 6a is wholly transferred onto the sheet S.

Then, Act 23 is ended.

The photoconductive drum 6a from which the toner image is transferred reaches the cleaning unit 6e. The cleaning unit 6e erases the residual toner left on the surface of the photoconductive drum 6a and recycles the erased residual toner.

The photoconductive drum 6a passing the cleaning unit 6e is irradiated by the light from the destaticization device 6f. The destaticization device 6f removes the residual charges on the surface of the photoconductive drum 6a.

The photoconductive drum 6a repeatedly carries out the foregoing image forming action.

The image forming apparatus 100 executes Act 24 after executing Act 23.

In Act 24, the image forming apparatus 100 fixes the toner image on the sheet S.

Before the sheet S arrives at the fixer 8, the main body control unit 9 controls the temperature of the fixer 8 at a predetermined fixation temperature, which is, for example, 180 degrees centigrade.

After entering the fixer 8, the sheet S receives heat and pressure from the fixer 8. The fixer 8 successively fixes the toner images on the sheet S. Further, the fixer 8 conveys the sheet S towards the paper discharging roller 5b. If the sheet S passes the fixer 8, then an FS is formed.

Then, Act 24 is ended.

The image forming apparatus 100 executes Act 25 after executing Act 24.

In Act 25, the image forming apparatus 100 discharges the FS to the sheet processing apparatus 110.

The main body control unit 9 drives the paper discharging roller 5b. The paper discharging roller 5b conveys the FS reaching the paper discharging roller 5b. The FS is discharged facing the first roller 10a of the sheet processing apparatus 110 opposite to the paper discharging roller 5b.

Then, Act 2 is ended while Act 25 is ended.

As shown in FIG. 6, the sheet processing apparatus 110 sequentially executes Acts 3-7 after executing Act 2.

In Act 3, the sheet processing apparatus 110 switches paper discharging paths.

The FS discharged from the paper discharging roller 5b arrives at the first roller 10a of the first conveyance unit 10A which is already driven. As shown in FIG. 11, the first roller 10a conveys the FS.

The first roller 10a arrives at the entry sensor S1. The entry sensor s1 sends a detection signal to the control unit 201.

After receiving the detection signal sent by the entry sensor s1, the control unit 201 drives the flapper switching unit 23 to cause the flapper 10f to enter the conveyance path between the second roller 10b and the third roller 10c.

Further, the control unit 201 drives the fourth roller 10e of the second conveyance unit 10B.

Then, Act 3 is ended.

The sheet processing apparatus 110 executes Act 3 after executing Act 3.

In Act 4, the sheet processing apparatus 110 inserts the FS into an LF.

If the FS conveyed by the first roller 10a arrives at the second roller 10b, then the FS is conveyed towards the third roller 10c by the second roller 10b.

However, the flapper 10f enters the conveyance path in Act 3. The FS arriving at the flapper 10f curves along the flapper 10f as the FS advances. The FS advances downwards along the conveyance path PFS between the conveyance guiding plates 10g.

The FS arrives at the fourth roller 10e of the second conveyance unit 10B. The fourth roller 10e conveys the FS downwards along the conveyance path PFS.

The recess 20c of the LF folded in Act 1 exists on the conveyance path PFS.

If the FS passes the entry sensor s2, then the entry sensor s2 sends a detection signal to the control unit 201. After receiving the detection signal from the entry sensor s2, then the control unit 201 stops the first roller 10a, the second roller 10b and the fourth roller 10e after a given time (refer to FIG. 11). The given time refers to the time elapsing from the moment the FS passes the entry sensor s2 to the moment the front end Sf of the FS is propped against the recess 20c.

The front end Sf of the FS is propped against the bottom of the recess 20c (refer to FIG. 12A).

Then, Act 4 is ended.

The sheet processing apparatus 110 executes Act 5 after executing Act 4.

In Act 5, the sheet processing apparatus 110 forms an SS.

The control unit 201 drives the first roller 10a, the second roller 10b, the fourth roller 10e and the folding roller 20 at the same linear speed. Further, the control unit 201 drives the first roller 12a, the second roller 12b and the heat rollers 13a and 13b at the linear speed at which the control unit 201 drives the folding roller 20. The control unit 201 heats the heating rollers 13a and 13b to a predetermined lamination temperature.

As shown in FIG. 12B, the front end adhesive part Cf′ clamped by the folding roller 20 is moved to a lower position.

The first part f1 and the second part f2 of the front end adhesive part Cf′ at the rear end are orderly clamped between the press rollers 20a and 20b. The first part f1, the FS and the second part f2 are laminated on the nip Nd. The first part f1, the FS and the second part f2 are pressurized by the press rollers 20a and 20b in the nip Nd. The first part f1, the FS and the second part f2 are conveyed downwards while the first part f1, the FS and the second part f2 are adhered to and laminated with each other. After the LF and the FS pass the press rollers 20a and 20b, then an SS is formed.

Then, Act 5 is ended.

The sheet processing apparatus 110 executes Act 6 after executing Act 5.

In Act 6, the sheet processing apparatus 110 forms an LS.

The SS entering the fourth conveyance unit 12 from the folding roller 20 is conveyed to the lamination unit 13 by the first rollers 12a and 12b.

In the SS, the FS is conveyed by the first part f1 and the second part f2 by being clamped between the first part f1 and the second part f2. In this way, the FS is not moved with respect to the first part f1 and the second part f2 when being conveyed. The width of the front end adhesive part Cf′ is not changed either during the conveyance process of the FS.

Before the SS arrives at the lamination unit 13, the heat rollers 13a and 13b are heated to a lamination temperature.

If the SS enters the lamination unit 13, the heat rollers 13a and 13b clamp and convey the SS. The heat rollers 13a and 13b heat and pressurize the SS.

When the SS is in the lamination unit 13, the thermoplastic resin layer of the SS is melted or softened. The thermoplastic resin layer is adhered to an opposite component. The opposite first part f1 and second part f2 are mutually adhered, so do the opposite first part f1 and FS and the opposite second part f2 and FS.

If the SS passes the lamination unit 13, then the thermoplastic resin layer is cooled. The adhesive part of the thermoplastic resin layer is solidified. In this way, the first part f1 of the SS, the FS and the second part f2 are integrated into a sheet. The SS becomes the LS shown in FIG. 5.

Then, Act 6 is ended.

The sheet processing apparatus 110 executes Act 7 after executing Act 6.

In Act 7, the sheet processing apparatus 110 discharges the LS.

The control unit 201 continues to drive the first roller 12a, the second roller 12b and the heat rollers 13a and 13b.

The LS is pulled out from the lamination unit 13 and is discharged to the LS discharging tray 16.

Then, Act 7 is ended.

The foregoing actions are successively carried out in a case where a plurality of FSs are formed. In this case, a plurality of LSs are orderly discharged onto the LS discharging tray 16.

The lamination mode is ended if images are formed on an operator-set number of sheets and the FSs are all discharged to the LS discharging tray 16.

The actions carried out in the lamination mode of a copy code are described above. The flapper 10f carries out no conveyance path switching in the image formation mode of the copy mode. The control unit 201 keeps the flapper 10f retreated from the conveyance path between the second roller 10b and the third roller 10c. Further, the control unit 201 drives the first conveyance unit 10A during the image formation mode. The control unit 201 stops the actions of the second conveyance unit 10B, the fourth conveyance unit 12 and the lamination unit 13.

In such an image formation mode, if an FS enters the first conveyance unit 10A, then the FS is sequentially discharged to the paper discharging tray 14 via the first conveyance unit 10A.

The actions carried out in the lamination mode of the printer mode are identical to the foregoing actions except that the scanner unit 2 is inoperative.

As stated above, the sheet processing apparatus 110 can automatically laminate an FS on which an image is formed by the image forming apparatus 100, thereby forming an LS. If an LF is held on the LF feeding unit 15, then the operator just needs to set the action mode of the image forming apparatus 100 to the lamination mode and press a start key. Thus, the sheet printed by the image forming apparatus 100 can be laminated easily and rapidly by the sheet processing apparatus 110.

A front end adhesive part Cf′ and a recess 20c are formed on the LF by the sheet processing apparatus 110. Further, the sheet processing apparatus 110 causes the FS to be impacted with and inserted into the recess 20c. In this way, the FS is located in the LF prior to a lamination processing and then laminated. The FS is laminated at a specific position in the LS.

Specifically, a front end adhesive part Cf is practically formed in the sheet processing apparatus 110.

Further, in the sheet processing apparatus 110, the operator can input a value through the control panel 1 to change D, thereby changing the width of the front end adhesive part Cf.

By changing the width of the front end adhesive part Cf in this way, the position where the FS in the LS is fixed can be changed.

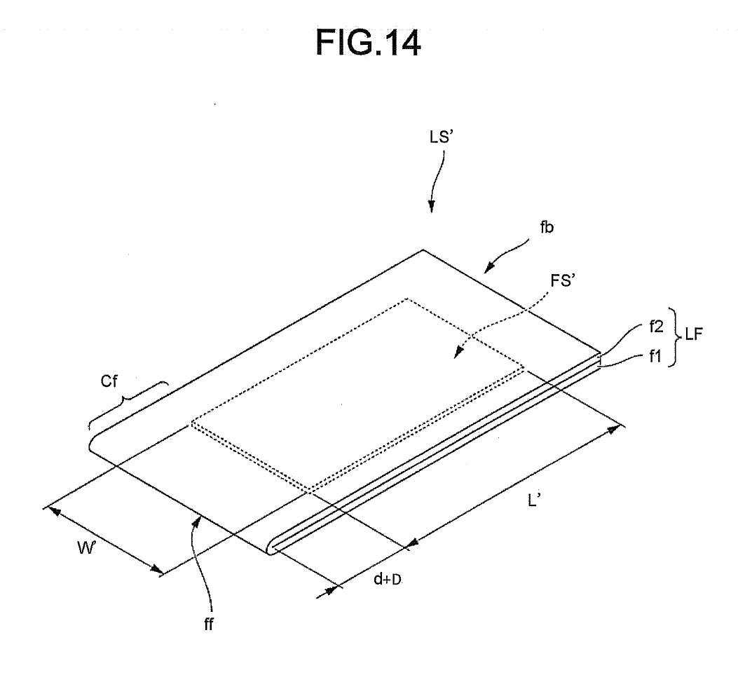

FIG. 14 is a three-dimensional schematic diagram exemplifying a lamination sheet formed by an image forming apparatus according to embodiment 1.

It is set that the size of the LF is greater than that of the FS. In this case, if the front end adhesive part Cf is just set to have the width needed for adhesion, then the FS is sometimes too close to the front end ff of the LS.

For example, in this case, in the sheet processing apparatus 110, the D can be changed to arrange the FS in the center of the LS.

The size of the front end adhesive part Cf of the LS′ shown in FIG. 14 is set to be d+D′ (D′>D). Thus, even if an FS′ smaller in shape than the LS′ can be located in the center of the LS′.

For example, the LF is set to have an A4 size (297 mm*210 mm). If the length and the width of the LF are set as follows: a L=10 (mm), ΔW=10 (mm), then the product of the length and the width is 614 mm*220 mm.

For example, an FS′ having a B5 size of L′ (257 mm)*W′ (182 mm) is laminated on the LF. In this case, if the width of the front end adhesive part Cf is set to be d+D (that is, 25 mm), then the FS′ can be arranged in the center of the LF in the length direction of the LF.

The ‘d+D’ can be input by the operator or automatically matched by the control unit 201. In this case, the size and the conveyance direction of a sheet S notified by the main body control unit 9 are sent to the control unit 201. The control unit 201 detects the size of the LF held on the LF feeding unit 15. The control unit 201 calculates the width of the front end adhesive part Cf needed for the centering of the sheet according to the size of the LF, the size of the sheet S and the conveyance direction of the sheet S.

A variation (a first variation) of embodiment 1 is described below.

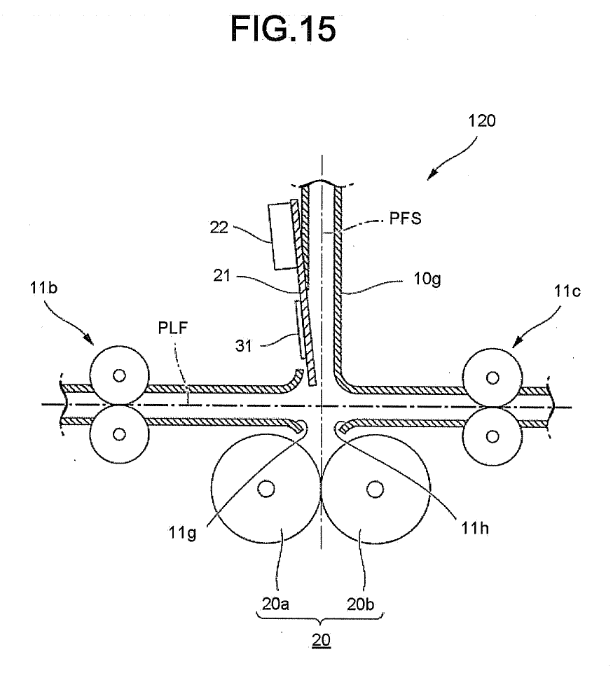

FIG. 15 is a schematic sectional view exemplifying the main structure of a sheet processing apparatus according to a variation (a first variation) of embodiment 1.

As shown in FIG. 15, in the sheet processing apparatus 120 of the first variation, a heater 31 is additionally arranged on the protrusion plate 21 of the sheet processing apparatus 110 of the foregoing embodiment 1.

The heater 31 heats the protrusion plate 21. The heating temperature of the heater 31 is sufficient to soften the base film of an LF but not sufficient for the adhesion of a thermoplastic resin layer with the protrusion plate 21.

In the variation, the front end of the protrusion plate 21 may be covered by a separating material so that the protrusion plate 21, even if heated, is not adhered to the thermoplastic resin layer.

The only difference of sheet processing apparatus 120 from the sheet processing apparatus 110 resides in that the protrusion plate 21 in an entered state is heated by the heater 31.

In the sheet processing apparatus 120, the protrusion plate 21 is heated by the heater 31 when heating an LF. The protrusion plate 21 heats the LF propped against the protrusion plate 21. The part of an LS nearby the protrusion plate 21 is softened.

Thus, it is easier to fold of the LF.

Further, the LF is clamped between the folding rollers 20 in such a manner that the temperature of the LF contacted with the heated protrusion plate 21 rises, thus improving the adhesive property of the front end adhesive part Cf′.

For example, because of the lower temperature in a cold place or in winter, it is sometimes difficult to curve an LF. If not folded sufficiently, the LF is likely to slide with respect to the folding rollers 20.

The use of the heater 31 guarantees the reliable adhesion of the LF with the surface of the folding rollers 20, thus preventing the sliding of the LF.

Further, a temperature sensor is arranged nearby the LF feeding unit 15. The heater 31 heats the protrusion plate 21 only when the temperature detected by the temperature sensor is below a certain value.

### Embodiment 2

A sheet processing apparatus according to embodiment 2 is described below.

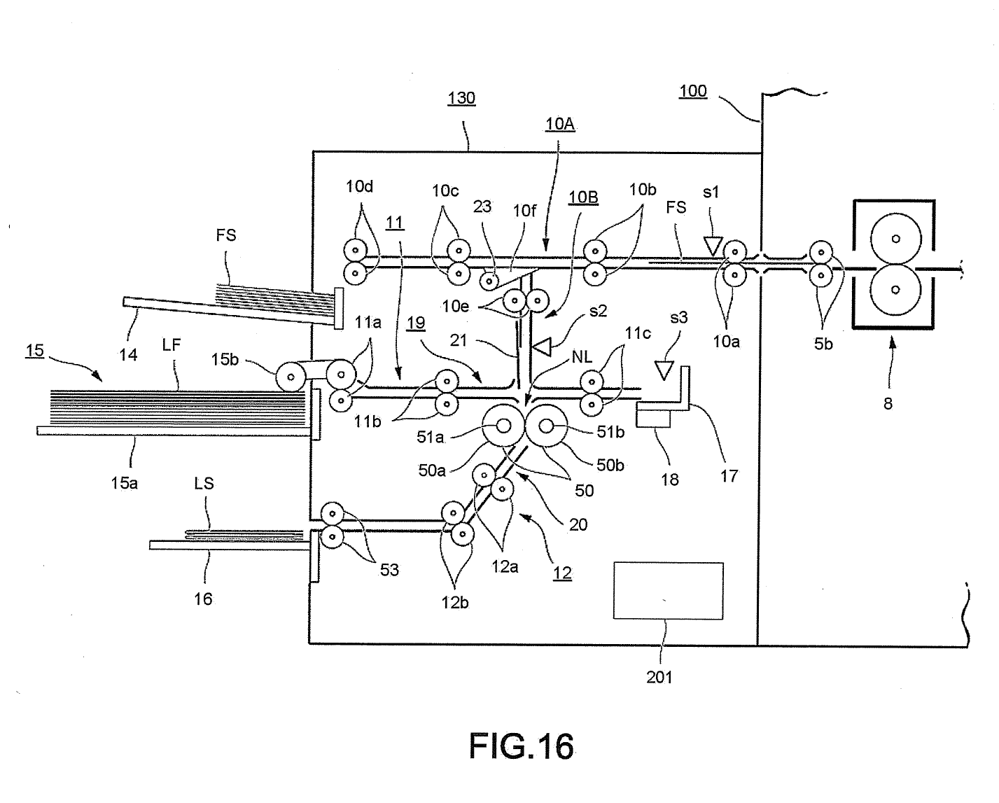

FIG. 16 is a schematic sectional view exemplifying the structure of a sheet processing apparatus according to embodiment 2.

As shown in FIG. 16, in the sheet processing apparatus 130 of embodiment 2, a lamination roller 50 (a folding unit, a pair of rollers, a film stacking unit and a lamination unit) and a paper discharging roller 53 replace the folding roller 20 and the lamination unit 13 of the sheet processing apparatus 110 of embodiment 1.

The lamination roller 50 is equipped with heating rollers 50a and 50b and heaters 51a and 51b.

The heating rollers 50a and 50b have the same outer diameter with the press rollers 20a and 20b. The heat rollers 50a and 50b have a rubber layer on the periphery of the hollow metal roller thereof.

The heat rollers 50a and 50b are propped against each other and pressurize each other, like the folding rollers 20. A nip NL is formed on the propped parts of the heat rollers 50a and 50b.

The width of the NL is set so that an SS can be laminated and pressurized during a lamination process.

The heaters 51a and 51b heat the heating rollers 50a and 50b from the inside of the heating rollers 50a and 50b. The heating temperature of the heaters 51a and 51b are suitable to laminate an SS.

The paper discharging roller 53 discharges the LS conveyed by the second roller 12b to the LS discharging tray 16.

The actions of the sheet processing apparatus 130 are described around those different from of the actions of the sheet processing apparatus 110 of embodiment 1.

The LF folding action of embodiment 2 is merely different in Act 14 shown in FIG. 7.

In the embodiment, to form a front end adhesive part Cf in Act 14, the control unit 201 heats the heaters 51a and 51b to a lamination temperature. However, if the front end adhesive part Cf can be formed, then the control unit 201 turns off the heaters 51a and 51b or reduces the temperature of the heaters 51a and 51b to a standby temperature lower than the lamination temperature.

The actions carried out by the image forming apparatus 100 and the sheet processing apparatus 130 in Acts 2, 3, and 4 in the embodiment are the same as those carried out in embodiment 1.

The present embodiment is different from in embodiment 1 in that Acts 5 and 6 are synchronously executed by the lamination roller 50.

The control unit 201 heats the heating rollers 51a and 51b to a lamination temperature.

The control unit 201 drives the first roller 10a, the second roller 10b, the fourth roller 10e and the folding roller 50 at the same linear speed. Further, the control unit 201 drives the first roller 12a, the second roller 12b and the paper discharging roller 53 at the linear speed of the lamination roller 50.

In the embodiment, an LS is merely discharged by the paper discharging roller 53 in Act 7, which is different from the discharging of an LS in embodiment 1.

Like the sheet processing apparatus 110 of embodiment 1, the sheet processing apparatus 130 of the embodiment is capable of laminating the image printed by the image forming apparatus 100 easily and rapidly.

Further, in the embodiment, the lamination roller 50 synchronously functions as a roller pair of a folding unit, a film stacking unit and a lamination unit.

Thus, the sheet processing apparatus 130 is structurally simpler than the sheet processing apparatus 110 of embodiment 1. The sheet processing apparatus 130 has fewer components than the sheet processing apparatus 110 of embodiment 1.

### Embodiment 3

The sheet processing apparatus according to embodiment 3 is described below.

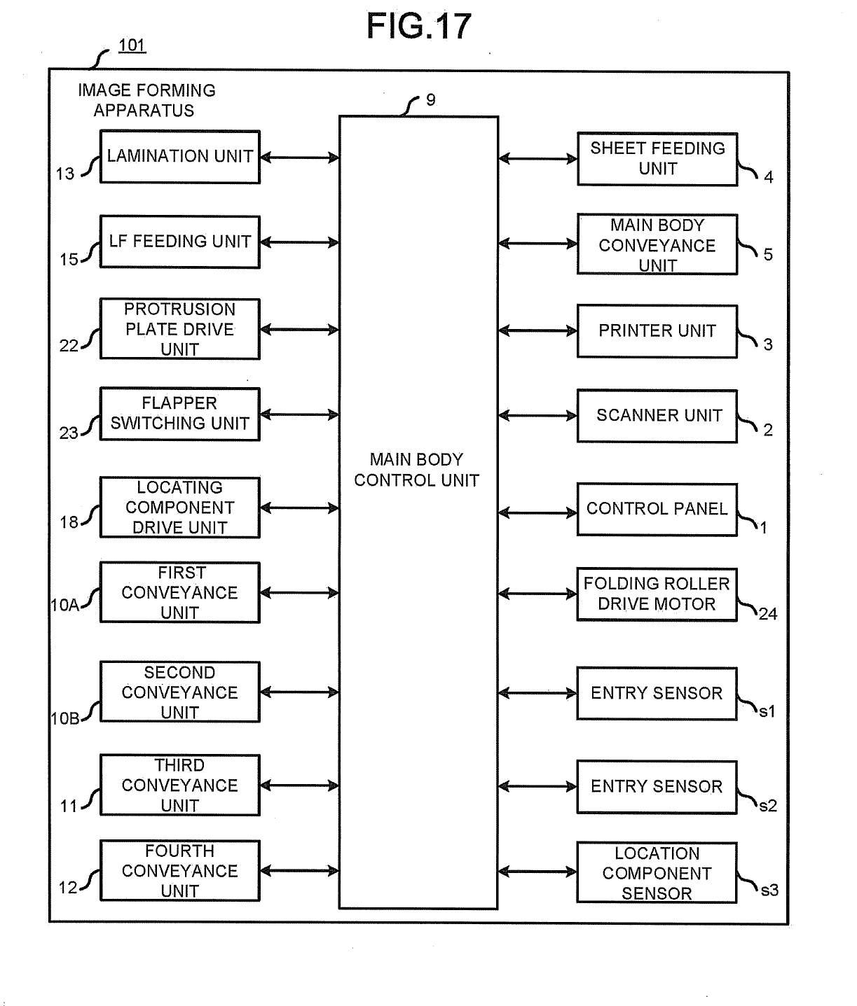

FIG. 17 is a block diagram exemplifying the functional structure of an image forming apparatus according to embodiment 3.

As shown in FIG. 17, the image forming apparatus 101 of embodiment 3 comprises the sheet processing apparatus 110 of the foregoing embodiment 1. Thus, the image forming apparatus 101 structurally comprises each component of the image forming apparatus 100 of embodiment 1 and each component of the sheet processing apparatus 110 of embodiment 1.

Each component of the sheet processing apparatus 110 may be controlled by the control unit 201, like in embodiment 1. However, as the main body control unit 9 has the control function of the control unit 201, the control unit 201 can be omitted.

FIG. 17 is a block diagram illustrating the control of the main body control unit 9 over each component of the image forming apparatus 101.

The actions carried out by the image forming apparatus 100 and the sheet processing apparatus 110 of embodiment 1 are carried out by the image forming apparatus 101 of the embodiment. The image forming apparatus 101 can automatically form an LS after forming an FS.

Like the image forming apparatus 100 and the sheet processing apparatus 110 of embodiment 1, the image forming apparatus 101 is capable of laminating the image printed easily and rapidly.

Variations of the foregoing embodiments are described below.

It is exemplified in the foregoing embodiments that image forming apparatuses carry out a single-color printing operation. However, the image forming apparatuses 100 and 101 may be image forming apparatuses for colorful printing.

Further, it is exemplified in the foregoing embodiments that the image forming apparatuses form an image after transferring and fixing a toner image. However, the image forming apparatuses may be, for example, inkjet printers which print an image by jetting ink onto a sheet S.

In at least one of the foregoing embodiments, a sheet forming apparatus comprises a first conveyance unit, a sheet discharging unit, an LF feeding unit, a locating unit, a folding unit, a second conveyance unit, a conveyance path switching unit, a film stacking unit and a lamination unit. Thus, the sheet forming apparatus is capable of laminating the sheet printed by an image forming apparatus easily and rapidly.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A sheet processing apparatus, comprising:
a first conveyance unit configured to convey a sheet discharged from an image forming apparatus;
a sheet discharging unit configured to discharge the sheet conveyed by the first conveyance unit;
a lamination film feeding unit configured to feed a lamination film;
a locating unit configured to locate the lamination film fed from the lamination film feeding unit;
a folding unit configured to fold the lamination film located at the locating unit to form a groove having a V-shaped section on the lamination film;
a second conveyance unit configured to insert the sheet conveyed by the first conveyance unit into the groove on the lamination film;
a conveyance path switching unit configured to switch the destination of the sheet conveyed by the first conveyance unit to either of the sheet discharging unit and the second conveyance unit;
a film stacking unit configured to cause the outer surface and the inner surface of the sheet inserted into the groove to adhere to the lamination film so as to form a lamination sheet; and
a lamination unit configured to laminate the lamination sheet.

2. The sheet processing apparatus according to claim 1, wherein
the folding unit comprises a protrusion plate which advances or retreats in a direction intersecting with the lamination film located at the locating unit and which forms the groove on the lamination film when in an entered state.

3. The sheet processing apparatus according to claim 2, wherein
the folding unit and the film stacking unit comprise a pair of rollers which have a nip extending parallel to the front end of the protrusion plate at the entry position of the protrusion plate;
the protrusion plate causes the lamination film to be pressed in a recess having a V-shaped section between the surfaces of the rollers so as to form the groove; and
the pair of rollers convey the lamination film inserted into the sheet at the groove into the nip and pressurize and convey the lamination film so as to form the stacked sheet.

4. The sheet processing apparatus according to claim 1, wherein
the locating unit is aligned to the central axis of the lamination film at the entry position of the protrusion plate.

5. The sheet processing apparatus according to claim 4, wherein
the locating unit is moved according to the size of the lamination film so as to be aligned with the central axis of the lamination film at the entry position of the protrusion plate.

6. The sheet processing apparatus according to claim 3, wherein
the pair of rollers advance and rotate the protrusion plate, convey the front end of the folded lamination film into the nip and form, on the front end of the folded lamination film and at the side of the front end of the groove, a front end adhesive part for the overlapping of the lamination films into a strip.

7. The sheet processing apparatus according to claim 6, wherein
the pair of rollers adjust the width of the front end adhesive part by changing the amount of the front end of the folded lamination film conveyed to the nip.

8. The sheet processing apparatus according to claim 2, wherein
the folding unit comprises a deformation guiding plate which guides the deformation of the lamination film at the position where the entry position of the protrusion plate is clamped along the entry direction of the protrusion plate when the protrusion plate enters the entry position.

9. The sheet processing apparatus according to claim 2, wherein
the folding unit, the film stacking unit and the lamination unit comprise a pair of rollers having a nip extending parallel to the front end of the protrusion plate at the entry position of the protrusion plate; and a heater configured to heat the pair of rollers;
the protrusion plate causes the lamination film to be pressed into a recess having a V-shaped section between the surfaces of the rollers so as to form the groove; and
the pair of rollers convey the lamination film the groove of which is inserted with the sheet, pressurize and heat the lamination film while conveying the lamination film, so as to form and laminate the stacked sheet.

10. A lamination method, comprising:
a first conveyance action of conveying a sheet discharged from an image forming apparatus;
feeding a lamination film;
locating the lamination film;
folding the located lamination film and forming a groove having a V-shaped section on the lamination film;
a second conveyance action of inserting the sheet conveyed through the first conveyance action into the groove on the lamination film;
causing the outer surface and the inner surface of the sheet inserted into the groove to adhere to the lamination film so as to form a lamination sheet; and
laminating the stacked sheet;
